(19) United States
(12) Patent Application Publication
(10) Pub. No.: US 2006/0228590 A1
(43) Pub. Date: Oct. 12, 2006

(54) Magnetic recording medium and production process therefor

(75) Inventors: Hiroshi Hashimoto, Kanagawa (JP); Yuichiro Murayama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/399,461

(22) Filed: Apr. 7, 2006

(30) Foreign Application Priority Data
Apr. 7, 2005 (JP) 2005-110935

(51) Int. Cl. G11B 5/716

(52) U.S. Cl. 428/840.5; 427/508; 427/127

(57) ABSTRACT

A magnetic recording medium is provided that comprises a non-magnetic support, at least one magnetic layer provided above the non-magnetic support, the magnetic layer comprising a ferromagnetic powder dispersed in a binder, and at least two radiation-cured layers provided between the non-magnetic support and the magnetic layer, each of the radiation-cured layers having been cured by exposing a radiation curing compound-containing layer to radiation.

### BACKGROUND OF THE INVENTION

1. Field of the Invention

The present invention relates to a magnetic recording medium having at least two radiation-cured layers and at least one magnetic layer above a non-magnetic support, and to a process for producing same. The magnetic recording medium of the present invention inludes a magnetic tape, a magnetic disc and the like, and has excellent electromagnetic conversion characteristics.

2. Description of the Related Art

As tape-form magnetic recording media for audio, video, and computers, and disc-form magnetic recording media such as flexible discs, a magnetic recording medium has been used in which a magnetic layer having dispersed in a binder a ferromagnetic powder such as γ-iron oxide, Co-containing iron oxide, chromium oxide, or a ferromagnetic metal powder is provided on a support. With regard to the support used in the magnetic recording medium, polyethylene terephthalate, polyethylene naphthalate, etc. are generally used. Since these supports are drawn and are highly crystallized, their mechanical strength is high and their solvent resistance is excellent.

Since the magnetic layer, which is obtained by coating the support with a coating solution having the ferromagnetic powder dispersed in the binder, has a high degree of packing of the ferromagnetic powder, low elongation at break and is brittle, it is easily destroyed by the application of mechanical force and might peel off from the support. In order to prevent this, an undercoat layer is provided on the support so as to make the magnetic layer adhere strongly to the support.

On the other hand, magnetic recording media are known in which a radiation-cured layer is formed using a compound having a functional group that is cured by radiation such as an electron beam, that is, a radiation curing compound (ref. JP-B-5-57647, JP-A-60-133529, JP-A-60-133530, and JP-A-60-133531; JP-B denotes a Japanese examined patent application publication, and JP-A denotes a Japanese unexamined patent application publication). These radiation-cured layers formed from the radiation curing compound have poor adhesion to the magnetic layer, and when such a magnetic recording medium, for example, a video tape, is run repeatedly in a VTR, a part of the magnetic layer peels off, thus giving rise to the problem of faults such as dropouts.

Recently, a playback head employing MR (magnetoresistance) as the operating principle has been proposed, its use in hard disks, etc. has started, and its application to magnetic tape has been proposed. The MR head gives a playback output several times that of an induction type magnetic head; since it does not use an induction coil, equipment noise such as impedance noise is greatly reduced, and by reducing the noise of the magnetic recording medium it becomes possible to obtain a large S/N ratio. In other words, by reducing the magnetic recording medium noise, which had previously been hidden by equipment noise, recording and playback can be carried out well, and the high density recording characteristics are outstandingly improved.

However, the MR head has the problem that it generates noise (thermal noise) under the influence of microscopic heating; in particular, it has the problem that when it hits a projection present on the surface of a magnetic layer, the noise suddenly increases and continues, and in the case of digital recording the problem can be so serious that error correction is impossible. This problem of thermal noise becomes serious in a magnetic recording medium used in a system in which a recorded signal having a recording density of 0.5 Gbit/inch² or higher is replayed.

In order to reduce such thermal noise, it is important to control the surface properties of the magnetic layer, and there has been a desire for suitable means to do this.

In order to improve the smoothness and the transport durability of a magnetic recording medium, a magnetic recording medium has therefore been proposed that contains polyurethane as a binder, which has high dispersibility of a magnetic powder and a non-magnetic powder, and a radiation curing type polyfunctional curing agent (ref. JP-A-2002-117521). However, even such magnetic recording medium can not provide a sufficient smoothness magnetic recording medium with the latest demand for higher recording density.

### BRIEF SUMMARY OF THE INVENTION

An object of the present invention is to provide a magnetic recording medium that has excellent smoothness and electromagnetic conversion characteristics.

In order to accomplish this object, the present invention employs the following constitution. That is, the present invention is a magnetic recording medium provided that comprises a non-magnetic support, at least one magnetic layer provided above the non-magnetic support, the magnetic layer comprising a ferromagnetic powder dispersed in a binder, and at least two radiation-cured layers provided between the non-magnetic support and the magnetic layer, each of the radiation-cured layers having been cured by exposing a radiation curing compound-containing layer to radiation.

### DETAILED DESCRIPTION OF THE INVENTION

The magnetic recording medium of the present invention is a magnetic recording medium provided with at least one magnetic layer constituted by dispersing a ferromagnetic powder in a binder above a non-magnetic support, wherein the magnetic recording medium includes at least two radiation-cured layers cured by exposing a radiation curing compound-containing layer to radiation between the non-magnetic support and the magnetic layer.

In general, in the magnetic recording medium, a magnetic recording medium having excellent electromagnetic conversion characteristics can be obtained by coating a layer containing a low viscosity radiation curing compound and radiation-curing the same to infill irregularities of the underlying layer to form an extremely smooth coating. However, in order to respond the demand for higher electromagnetic conversion characteristics, it is necessary to infill finer irregularities, and, for the purpose, to increase a thickness of the radiation-cured layer. The increase in coating thickness brings about such problem that an increased total thickness of a magnetic recording medium decreases recording density per volume of the medium.

The present inventors have been found that, as the results of various investigations, fine irregularities remaining on the surface of the radiation-cured layer is due to insufficiency in leveling and curing shrinkage, and that, in order to make it smaller, it is extremely effective to coat and cure the radiation curing layer in plural times such as two or three times even when they give the same total thickness. As the result, it has been found that the above-mentioned constitution can give a magnetic layer having extremely excellent in smoothness of the coated surface.

Since the magnetic recording medium of the present invention can reduce micro projections on the magnetic layer surface that causes the noise and has, in particular, such very small thickness of the magnetic layer as 20 to 200 nm, it can be preferably used for magnetic recording using an MR head for use in high recording density applications.

In a magnetic recording medium, use of a support previously having a very few projections may be conceived. However, an extremely smooth support has a high friction coefficient and brings about such problem that, particularly in the case of a thin support of 10 μm or less, production yield significantly lowers due to generation of wrinkle and meandering on convey rolls during a conveying or winding step in a production process of a support or a coating process of a magnetic tape. By employing the above-mentioned structure of the present invention, it is also possible to use a support having moderate irregularities.

The present invention is explained in more detail below.

I. Radiation-Cured Layer

I-1. Radiation Curing Compound

With regard to a radiation curing compound used in the present invention, a compound that responses an active radiation to cure can be used.

Examples of such radiation curing compound include a compound having an ethylenic double bond or a compound having a cyclic ether (such as an epoxy group and an oxetane group). In the present invention, a compound having an ethylenic unsaturated bond is used preferably, and examples thereof include acrylic esters, acrylamides, methacrylic esters, methacrylic amides, allyl compounds, vinyl ethers and vinyl esters.

In the present invention, use of a polyfunctional radiation curing compound having 2 to 10 ethylenic unsaturated groups in a molecule is preferable.

Specific examples of difunctional (meth)acrylate compounds include following compounds.

Here, ‘(meth)acrylate’ is an abbreviated expression representing that both cases of ‘acrylate and methacrylate structures’ and ‘acrylate or methacrylate structure’ are possible; and ‘(meth)acrylic acid’ is an abbreviated expression representing that both cases of ‘acrylic acid and methacrylic acid’ and ‘acrylic acid or methacrylic acid’ are possible.

Examples of compounds formed by adding (meth)acrylic acid to an aliphatic diol include ethylene glycol diacrylate, propylene glycol diacrylate, butanediol diacrylate, hexanediol diacrylate, neopentyl glycol diacrylate, ethylene glycol dimethacrylate, propylene glycol dimethacrylate, butanediol dimethacrylate, hexanediol dimethacrylate, neopentyl glycol dimethacrylate; (meth)acrylate compounds of alicyclic diols such as cyclohexanediol diacrylate, cyclohexanediol dimethacrylate, cyclohexane dimethanol diacrylate, cyclohexane dimethanol dimethacrylate, hydrogenated bisphenol A diacrylate, hydrogenated bisphenol A dimethacrylate, hydrogenated bisphenol F diacrylate, hydrogenated bisphenol F dimethacrylate, tricyclodecane dimethanol diacrylate, and tricyclodecane dimethanol dimethacrylate.

Examples of compounds formed by adding (meth)acrylic acid to a polyether polyol include polyether (meth)acrylates formed by adding acrylic acid or methacrylic acid to a polyether polyol such as polyethylene glycol, polypropylene glycol or polytetramethylene glycol, including diethylene glycol diacrylate, triethylene glycol diacrylate, tetraethylene glycol diacrylate, dipropylene glycol diacrylate, tripropylene glycol diacrylate, diethylene glycol dimethacrylate, triethylene glycol dimethacrylate, tetraethylene glycol dimethacrylate, dipropylene glycol dimethacrylate, and tripropylene glycol dimethacrylate.

As a compound formed by adding (meth)acrylic acid to a polyester polyol, it is also possible to use a polyester polyol obtained from a known dibasic acid and a known glycol, and polyester (meth)acrylate formed by adding (meth)acrylic acid to a polyester polyol obtained by ring-opening polymerization of a cyclic ester such as ε-caprolactone.

Furthermore, as a difunctional (meth)acrylate compound, it is possible to use a polyurethane (meth)acrylate formed by adding acrylic acid or methacrylic acid to a OH end group-including polyurethane obtained by reacting a known polyol or diol with polyisocyanate.

Inversely, it is also possible to use a urethane acrylate oligomer obtained by reacting an isocyanate end group-including urethane oligomer with hydroxyethyl acrylate, hydroxyethyl methacrylate, or pentaerythritol triacrylate.

It is also possible to use those obtained by adding acrylic acid or methacrylic acid to bisphenol A, bisphenol F, hydrogenated bisphenol A, hydrogenated bisphenol F, or an alkylene oxide adduct thereof; an isocyanuric acid alkylene oxide-modified diacrylate, an isocyanuric acid alkylene oxide-modified dimethacrylate, etc.

An epoxyester (meth)acrylate obtained by reacting an epoxy resin having an epoxy group with (meth)acrylic acid or the like can be also used.

As trifunctional (meth)acrylate compounds there can be used trimethylolpropane triacrylate, trimethylolethane triacrylate, an alkylene oxide-modified triacrylate of trimethylolpropane, pentaerythritol triacrylate, dipentaerythritol triacrylate, an isocyanuric acid alkylene oxide-modified triacrylate, propionic acid dipentaerythritol triacrylate, a hydroxypivalaldehyde-modified dimethylolpropane triacrylate, trimethylolpropane trimethacrylate, an alkylene oxide-modified trimethylolpropane trimethacrylate, pentaerythritol trimethacrylate, dipentaerythritol trimethacrylate, an isocyanuric acid alkylene oxide-modified trimethacrylate, propionic acid dipentaerythritol trimethacrylate, a hydroxypivalaldehyde-modified dimethylolpropane trimethacrylate, etc.

As tetra- or higher-functional (meth)acrylate compounds there can be used pentaerythritol tetraacrylate, ditrimethylolpropane tetraacrylate, dipentaerythritol pentaacrylate, propionic acid dipentaerythritol tetraacrylate, dipentaerythritol hexaacrylate, an alkylene oxide-modified hexaacrylate of phosphazene, etc.

Specific examples of more preferable radiation curing compounds include dipropylene glycol diacrylate, tripropylene glycol diacrylate, hydrogenated bisphenol A diacrylate, hydrogenated bisphenol A dimethacrylate, tricyclodecane dimethanol diacrylate, tricyclodecane dimethanol dimethacrylate, urethane acrylate oligomer, polyester acrylate oligomer and epoxyester acrylate.

With regard to the radiation curing compound used in the present invention, a cationic polymerizable compound having at least one cyclic ether group or vinyl ether group in a molecule can be used in place of, or in combination with the above-mentioned compound having an ethylenic double bond. As the cation-polymerizable compound used in the present invention, a known cation-polymerizable monomer that starts polymerization and cures with a photo cation-polymerization initiator to be described below can be used. As the cation-polymerizable monomer, there can be cited epoxy compounds, vinyl ether comounds, and oxetane compounds that are described in, for example, JP-A-6-9714, JP-A-2001-31892, JP-A-2001-40068, JP-A-2001-55507, JP-A-2001-310938, JP-A-2001-310937 and JP-A-2001-220526.

As the epoxy compound, an aromatic epoxide, an alicyclic epoxide, an aliphatic epoxide and the like can be cited. As the aromatic epoxide, there can be cited di- or poly-glycidyl ether manufactured by reacting a polyhydric phenol having at least one aromatic nuclear or an alkylene oxide adduct thereof with epichlorohydrin, including, for example, di- or poly-glycidyl ether of bisphenol A or alkylene oxide adduct thereof, di- or poly-glycidyl ether of hydrogenated bisphenol A or alkylene oxide adduct thereof, and novolac type epoxy resin. As the alkylene oxide, ethylene oxide, propylene oxide and the like can be cited.

As the alicyclic epoxide, there can be preferably cited a cyclohexene oxide- or cyclopentene oxide-containing compound obtained by epoxidizing a compound having at least one cycloalkene ring such as a cyclohexene ring or a cyclopentene ring with an appropriate oxidizing agent such as hydrogen peroxide or peracid.

As the aliphatic epoxide, there are di- or poly-glycidyl ether of an aliphatic polyhydric alcohol or an alkylene oxide adduct thereof and the like, including, as representative examples, alkylene glycol diglycidyl ether such as ethylene glycol diglycidyl ether, propylene glycol diglycidyl ether and 1,6-hexanediol diglycidyl ether; polyhydric alcohol polyglycidyl ether such as di- or tri-glycidyl ether of glycerin or an alkylene oxide adduct thereof; polyalkylene glycol diglycidyl ether as represented by diglycidyl ether of polyethylene glycol or an alkylene oxide adduct thereof and diglycidyl ether of polypropylene glycol or an alkylene oxide adduct thereof. As the alkylene oxide, there can be cited ethylene oxide, propylene oxide and the like.

The radiation curing compound used in the present invention includes preferably a polyfuncrional (meth)acrylate compound, more preferably a 2 to 10 functonal compound, and further preferably a 2 to 6 functional compound. The compound having the number of functional groups within the above-mentioned range results in a compund showing a little curing shrinkage and low decrease in adhesion with a support, which is preferable.

The molecular weight of the radiation curing compound used in the present invntion is preferably 200 to 10,000, and more preferably 200 to 5,000. The molecular weight within the above-mentioned range gives low viscosity and high leveling to give improved smoothness, which is preferable.

The radiation curing compound used in the present invention is preferably a 2 to 6 functional (meth)acrylate compound having a molecular weight of 200 to 10,000, and particularly preferably a 2 to 6 functional (meth)acrylate compound having a molecular weight of 200 to 600.

The magnetic recording medium of the present invention preferably has at least one layer formed of a radiation curing compound alone among 2 or more of radiation-cured layers, and more preferably the above layer formed of a radiation curing compound alone is a layer provided on the side nearer to the support among 2 or more of radiation-cured layers.

The radiation curing compound used in the present invention may be used singly or in a mixture of 2 or more types at an any ratio.

In the radiation-cured layer used in the present invention, a monofunctional (meth)acrylate compound may be used in combination as a reactive diluent in addition to the above-mentioned radiation curing compound. As the reactive diluent, a known mono functional (meth)acrylate compound may be preferably used, including those described in ‘Teienerugi Denshisenshosha no Oyogijutsu’ (Applied Technology of Low-energy Electron Beam Irradiation) (2000, Published by CMC), ‘UV•EB Kokagijutsu’ (UV•EB Curing Technology) (1982, Published by Sogo Gijutsu Center), etc.

A preferable structure as the above-mentioned monofunctional (meth)acrylate compounde is a (meth)acrylate compound having an alicyclic hydrocarbon skeleton. Specific examples include cyclohexyl(meth)acrylate, isobornyl(meth)acrylate, and tetrahydrofurfuryl(meth)acrylate.

The blending amount of the monofunctional radiation curing compound is preferably 10 to 90 wt % relative to the polyfunctional radiation curing compound.

I-2. Curing by Radiation

The radiation used in the present invention may be an electron beam or ultraviolet rays.

The ‘radiation’ in the present invention is not particularly limited as long as it is an active radiation that can give energy capable of generating polymerization-initiating species by irradiation thereof, widely including such as α-rays, γ-rays, X-rays, ultraviolet rays, visible rays, an electron beam.

When ultraviolet rays are used, it is preferable to add a photopolymerization initiator to the radiation curing compound. In the case of curing with an electron beam, no polymerization initiator is required, and the electron beam has a deep penetration depth, which is preferable.

With regard to electron beam accelerators that can be used here, there are a scanning system, a double scanning system, and a curtain beam system, and the curtain beam system is preferable since it is relatively inexpensive and gives a high output. With regard to electron beam characteristics, the acceleration voltage is 30 to 1,000 kV, and preferably 50 to 300 kV. The absorbed dose is 5 to 200 kGy, and preferably 20 to 100 kGy. When the acceleration voltage is in the above-mentioned range, the amount of energy penetrating is sufficient, and the efficiency of energy usage in polymerization is high, which is economical.

The electron beam irradiation atmosphere is preferably controlled by a nitrogen purge so that the concentration of oxygen is 200 ppm or less. When the concentration of oxygen is 200 ppm or less, crosslinking and curing reactions in the vicinity of the surface are not inhibited.

As a light source for the ultraviolet rays, a mercury lamp is used. The mercury lamp is a 20 to 240 W/cm lamp and is used at a speed of 0.3 to 20 m/min. The distance between a substrate and the mercury lamp is generally preferably 1 to 30 cm.

As the photopolymerization initiator used for ultraviolet curing, a radical photopolymerization initiator is used. More particularly, those described in, for example, ‘Shinkobunshi Jikkenngaku’ (New Polymer Experiments), Vol. 2, Chapter 6 Photo/Radiation Polymerization (Published by Kyoritsu Publishing, 1995, Ed. by the Society of Polymer Science, Japan) can be used. Specific examples thereof include acetophenone, benzophenone, anthraquinone, benzoin ethyl ether, benzil methyl ketal, benzil ethyl ketal, benzoin isobutyl ketone, hydroxydimethyl phenyl ketone, 1-hydroxycyclohexyl phenyl ketone, and 2,2-diethoxyacetophenone.

The mixing ratio of the photopolymerization initiator is preferably 0.5 to 20 parts by weight relative to 100 parts by weight of the radiation curing compound, more preferably 2 to 15 parts by weight, and yet more preferably 3 to 10 parts by weight.

I-3. The Glass Transition Temperature (Tg) after Curing

The glass transition temperature (Tg) of the radiation-cured layer after curing is preferably 80 to 150° C., and more preferably 100 to 130° C. When the glass transition temperature is in the above-mentioned range, the problem of tackiness during a coating step can be suppressed, and good coating strength can be obtained, which is preferable.

I-4. Thickness of Radiation-Cured Layer

The thickness of each of the radiation-cured layers is preferably 0.05 to 1.0 μm, and more preferably 0.1 to 0.5 μm.

The total thickness obtained by summing the thickness of respective radiation-cured layers is preferably 0.15 to 3.0 μm, and more preferably 0.3 to 1.5 μm.

The thickness of each of the radiation-cured layers and/or the total thickness of the radiation-cured layers falling in the above-mentioned range can give sufficient dynamic strength of a tape as well as sufficient smoothness to result in good durability, which is preferable.

I-5. Elastic Modulus of Radiation-Cured Layer

The elastic modulus of the radiation-cured layer is preferably 1.5 to 4 GPa. When the elastic modulus is in the above-mentioned range, the coated film does not suffer from sticking trouble and has good film strength, which is preferable.

I-6. Surface Roughness of Radiation-Cured Layer

The surface roughness (Ra) of the radiation-cured layer is preferably 1 to 3 nm for a cutoff value of 0.25 mm, and more preferably 1.0 to 2.0 nm. The roughness in the above-mentioned range does not induce adhesion fault to pass rolls during the coating process and can give sufficient smoothness of the magnetic layer, which is preferable.

I-7. Number of Radiation-Cured Layers

The radiation-cured layer of the magnetic recording medium of the present invention is a radiation-cured layer formed by curing a radiation curing compound-containing layer by exposure to radiation. There are at least 2 such layers between a non-magnetic support and a magnetic layer. The number of the radiation-cured layers is at least 2, preferably 2 to 4, more preferably 2 or 3, and particularly preferably 3.

I-8. Other Additives

The radiation-cured layer of the magnetic recording medium of the present invention may have been added with an inorganic powder, carbon black, an organic powder, resin or the like described below. Further, an abrasive, a lubricant, a dispersant/dispersion adjuvant, an anti-mold agent, an antistatic agent, an antioxidant, a solvent or the like used for the magnetic layer or the non-magnetic layer described below may be also used as an additive for the radiation-cured layer. In particular, the amount and type of additive and dispersant can be determined according to a known techniques regarding the magnetic layer.

<Inorganic Powder>

The inorganic powder used in the present invention can be added to the radiation-cured layer.

The inorganic powder used in the present invention can be chosen from inorganic compounds such as a metal oxide, a metal carbonate, a metal sulfate, a metal nitride, a metal carbide, and a metal sulfide, and it is possible to use the same as an inorganic powder used in a non-magnetic layer provided thereon by coating. For example, α-alumina with an a component proportion of at least 90%, α-alumina, γ-alumina, θ-alumina, silicon carbide, chromium oxide, cerium oxide, α-iron oxide, goethite, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, etc. can be used singly or in combination. From the viewpoint of a narrow particle size distribution, the possibility of having many means for imparting functionality, etc., titanium dioxide, zinc oxide, iron oxide and barium sulfate are preferable, and titanium dioxide and α-iron oxide are more preferable.

The particle size of such an inorganic powder is preferably 0.005 to 2 μm, but it is also possible, as necessary, to combine inorganic powders having different particle sizes or widen the particle size distribution of a single inorganic powder, thus producing the same effect. The particle size of the inorganic powder is particularly preferably 0.01 to 0.2 μm. In particular, when the inorganic powder is a granular metal oxide, the average particle size is preferably 0.08 μm or less. When it is an acicular metal oxide, the major axis length is preferably 0.3 μm or less, and more preferably 0.1 μm or less. The tap density is 0.05 to 2 g/ml, and preferably 0.2 to 1.5 g/ml.

The water content of the inorganic powder is preferably 0.1 to 5 wt %, more preferably 0.2 to 3 wt %, and particularly preferably 0.3 to 1.5 wt %. The pH of the inorganic powder is preferably 2 to 11, and particularly preferably in the range of 5.5 to 10. The specific surface area (S_{BET}) of the inorganic powder is preferably 1 to 100 m²/g, more preferably 5 to 80 m²/g, and yet more preferably 10 to 70 m²/g. The crystallite size is preferably 0.004 to 1 μm, and more preferably 0.04 to 0.1 μm. The oil absorption measured using DBP (dibutyl phthalate) is preferably 5 to 100 ml/100 g, more preferably 10 to 80 ml/100 g, and yet more preferably 20 to 60 ml/100 g. The specific gravity is preferably 1 to 12, and more preferably 3 to 6. The form may be any one of acicular, spherical, polyhedral, and tabular.

The ignition loss is preferably 20 wt % or less, and it is most preferable that there is no ignition loss. The Mohs hardness of the inorganic powder used in the present invention is preferably in the range of 4 to 10. The roughness factor of the surface of the powder is preferably 0.8 to 1.5, and more preferably 0.9 to 1.2. The amount of SA (stearic acid) absorbed by the inorganic powder is preferably 1 to 20 μmol/m², more preferably 2 to 15 μmol/m², and yet more preferably 3 to 8 μmol/m². The heat of wetting of the inorganic powder in water at 25° C. is preferably in the range of 200 to 600 erg/cm². It is preferable to use a solvent that gives a heat of wetting in this range, and the pH is preferably between 3 and 6.

The surface of the inorganic powder is preferably subjected to a surface treatment so that Al₂O₃, SiO₂, TiO₂, ZrO₂, SnO₂, Sb₂O₃, ZnO, or Y₂O₃ is present. In terms of dispersibility in particular, Al₂O₃, SiO₂, TiO₂, and ZrO₂ are preferable, and Al₂O₃, SiO₂, and ZrO₂ are more preferable. They may be used in combination or singly. Depending on the intended purpose, a surface-treated layer may be obtained by co-precipitation, or a method in which it is firstly treated with alumina and the surface thereof is then treated with silica, or vice versa, can be employed. The surface-treated layer may be formed as a porous layer depending on the intended purpose, but it is generally preferable for it to be uniform and dense.

Specific examples include Nanotite (manufactured by Showa Denko K.K.), HIT-100 and ZA-G1 (manufactured by Sumitomo Chemical Co., Ltd.), α-hematite DPN-250, DPN-250BX, DPN-245, DPN-270BX, DBN-SA1, and DBN-SA3 (manufactured by Toda Kogyo Corp.), titanium oxide TTO-51B, TTO-55A, TTO-55B, TTO-55C, TTO-55S, TTO-55D, SN-100, α-hematite E270, E271, E300, and E303 (manufactured by Ishihara Sangyo Kaisha Ltd.), titanium oxide STT-4D, STT-30D, STT-30, STT-65C, and α-hematite α-40 (manufactured by Titan Kogyo Kabushiki Kaisha), MT-100S, MT-100T, MT-150W, MT-500B, MT-600B, MT-100F, and MT-500HD (manufactured by Tayca Corporation), FINEX-25, BF-1, BF-10, BF-20, and ST-M (manufactured by Sakai Chemical Industry Co., Ltd.), DEFIC-Y and DEFIC-R (manufactured by Dowa Mining Co., Ltd.), AS2BM and TiO₂P25 (manufactured by Nippon Aerosil Co., Ltd.), and 100A, 500A and calcined products thereof (manufactured by Ube Industries, Ltd.).

Particularly preferred inorganic powders are titanium dioxide and α-iron oxide. α-iron oxide (hematite) is employed under the various conditions below. That is, with regard to the α-Fe₂O₃ powder used in the present invention, its precursor particles are acicular goethite particles obtained by, for example, a normal method (1) for forming acicular goethite particles in which a ferrous hydroxide colloid-containing suspension obtained by adding at least an equivalent amount of an aqueous solution of an alkali hydroxide to an aqueous ferrous solution is subjected to an oxidation reaction at a pH of 11 or higher at a temperature of 80° C. or less while passing an oxygen-containing gas therethrough, a method (2) for forming spindle-shaped goethite particles in which an oxidation reaction is carried out by passing an oxygen-containing gas into a suspension containing FeCO₃ obtained by reacting an aqueous solution of a ferrous salt and an aqueous solution of an alkali carbonate, a method (3) for forming acicular goethite nuclei particles by carrying out an oxidation reaction by passing an oxygen-containing gas into an aqueous solution of a ferrous salt containing a ferrous hydroxide colloid obtained by adding less than an equivalent amount of an aqueous solution of an alkali hydroxide or an alkali carbonate to an aqueous solution of a ferrous salt, and subsequently growing the acicular goethite nuclei particles by adding an aqueous solution of an alkali hydroxide to the aqueous solution of the ferrous salt containing the acicular goethite nuclei particles in an amount that is at least equivalent to the Fe²⁺ in the aqueous solution of the ferrous salt, and then passing through an oxygen-containing gas, and a method (4) for forming acicular goethite nuclei particles by carrying out an oxidation reaction by passing an oxygen-containing gas into an aqueous solution of a ferrous salt containing a ferrous hydroxide colloid obtained by adding less than an equivalent amount of an aqueous solution of an alkali hydroxide or an alkali carbonate to an aqueous ferrous solution, and subsequently growing the acicular goethite nuclei particles in an acidic to neutral region.

During the reaction to form goethite particles, different types of elements such as Ni, Zn, P, and Si, which are normally added in order to improve the characteristics of the powder, etc., may be added without any problem. The acicular goethite particles, which are the precursor particles, are dehydrated at a temperature in the range of 200 to 500° C., and if necessary further annealed by heating at a temperature in the range of 350 to 800° C. to give acicular α-Fe₂O₃ particles. An anti-sintering agent such as P, Si, B, Zr, or Sb can be attached without problem to the surface of the acicular goethite particles that are to be dehydrated or annealed. Annealing by heating at a temperature in the range of 350 to 800° C. is carried out for blocking pores formed on the surface of the dehydrated acicular α-Fe₂O₃ particles by melting the very surface of the particles, thus giving a smooth surface configuration, which is preferable.

The α-Fe₂O₃ powder used in the radiation-cured layer is obtained by subjecting the dehydrated or annealed acicular α-Fe₂O₃ particles to dispersion in an aqueous solution to give a suspension, coating the surface of the α-Fe₂O₃ particles with an Al compound by adding the compound and adjusting the pH, and further subjecting the particles to filtration, washing with water, drying, grinding, and if necessary further degassing/compacting, etc. As the Al compound used, an aluminum salt such as aluminum acetate, aluminum sulfate, aluminum chloride, or aluminum nitrate or an alkali aluminate such as sodium aluminate can be used. In this case, the amount of Al compound added on an Al basis is preferably 0.01 to 50 wt % relative to the α-Fe₂O₃ powder. When it is in this range, it is preferable that the dispersibility thereof in a binder resin is good, the Al compounds suspended on the particle surface are little, and the interaction with the Al compounds each other is little.

With regard to the inorganic powder used in the radiation-cured layer, the coating can be carried out using, in addition to the Al compound, one or two or more types of compounds chosen from an Si compound, and P, Ti, Mn, Ni, Zn, Zr, Sn, and Sb compounds. The amount of such a compound used together with the Al compound is preferably in the range of 0.01 to 50 wt % relative to the α-Fe₂O₃ powder. When the amount added is in the above-mentioned range, it is preferably that the effect of improving the dispersibility by the addition is good, and the compounds suspended on the particle surface are little, and the interaction with the Al compounds each other is little.

Methods for producing titanium dioxide are as follows. The main methods for producing titanium oxide are a sulfuric acid method and a chlorine method. In the sulfuric acid method, an ilmenite ore is digested with sulfuric acid, and Ti, Fe, etc. are extracted as sulfates. Iron sulfate is removed by crystallization, the remaining titanyl sulfate solution is purified by filtration and then subjected to thermal hydrolysis so as to precipitate hydrated titanium oxide. After this is filtered and washed, impurities are removed by washing, a particle size regulator, etc. is added thereto, and the mixture is calcined at 80 to 1,000° C. to give crude titanium oxide. The rutile type and the anatase type can be separated according to the type of a nucleating agent that is added when carrying out hydrolysis. This crude titanium oxide is subjected to grinding, size adjustment, surface treatment, etc. As an ore for the chlorine method, natural rutile or synthetic rutile is used. The ore is chlorinated at high temperature under reducing conditions, Ti is converted into TiCl₄ and Fe is converted into FeCl₂, and iron oxide solidifies by cooling and is separated from liquid TiCl₄. The crude TiCl₄ thus obtained is purified by distillation, then a nucleating agent is added, and the mixture is reacted momentarily with oxygen at a temperature of 1,000° C. or higher to give crude titanium oxide. A finishing method for imparting pigmentary properties to the crude titanium oxide formed by this oxidative decomposition process is the same as that for the sulfuric acid method.

The surface treatment is carried out by dry-grinding the above-mentioned titanium oxide material, then adding water and a dispersant thereto, and subjecting it to rough classification by wet-grinding and centrifugation. Subsequently, the fine grain slurry is transferred to a surface treatment vessel, and here surface coating with a metal hydroxide is carried out. Firstly, a predetermined amount of an aqueous solution of a salt such as Al, Si, Ti, Zr, Sb, Sn, or Zn is added, an acid or an alkali for neutralizing this is added, and the hydrated oxide thus formed is used for coating the surface of the titanium oxide particles. Water-soluble salts produced as a by-product are removed by decantation, filtration, and washing. Finally the pH of the slurry is adjusted, and it is filtered and washed with pure water. The cake thus washed is dried by a spray dryer or a band dryer. This dried product is ground using a jet mill to give a final product.

In addition to the an aqueous system, it is also possible to expose a titanium oxide powder to AlCl₃ or SiCl₄ vapor and then to steam, thereby carrying out a surface treatment with Al or Si. Other methods for preparing a pigment can be referred to in G. D. Parfitt and K. S. W. Sing, ‘Characterization of Powder Surfaces’ Academic Press, 1976.

<Carbon Black>

It is possible to add carbon black to the radiation-cured layer used in the present invention. Incorporation of carbon black can give the known effects of a lowering of surface electrical resistance (Rs), a reduction in light transmittance, and giving a desired micro Vickers hardness. Not adding any carbon black at all is also a preferred embodiment.

Types of carbon black that can be used include furnace black for rubber, thermal black for rubber, black for coloring, and acetylene black. The carbon black used in the radiation-cured layer should have characteristics that have been optimized as follows according to a desired effect, and the effect can be increased by the use thereof in combination.

The specific surface area of the carbon black is preferably 100 to 500 m²/g, and more preferably 150 to 400 m²/g, and the DBP oil absorption thereof is preferably 20 to 400 m/1100 g, and more preferably 30 to 200 ml/100 g. The particle size of the carbon black is preferably 5 to 80 nm, more preferably 10 to 50 nm, and yet more preferably 10 to 40 nm. The pH of the carbon black is preferably 2 to 10, the water content is preferably 0.1 to 10%, and the tap density is preferably 0.1 to 1 g/ml.

Specific examples of the carbon black used in the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, MA-600, MA-230, #4000 and #4010 (manufactured by Mitsubishi Chemical Corporation), CONDUCTEX SC, RAVEN 8800, 8000, 7000, 5750, 5250, 3500, 2100, 2000, 1800, 1500, 1255 and 1250 (manufactured by Columbia Carbon Co.), Ketjen Black EC (manufactured by Akzo) and Ketjen Black EC (manufactured by Ketjen Black International Corporation Ltd.).

The carbon black may be subjected to any of a surface treatment with a dispersant, etc., grafting with a resin, or a partial surface graphitization. The carbon black may also be dispersed in a binder prior to addition to a coating solution. The carbon black can be preferably used in a range not exceeding 50 wt % relative to the above-mentioned inorganic powder. The carbon black can be used alone or in a combination of different types thereof. The carbon black that can be used in the present invention can be referred to in, for example, the ‘Kabon Burakku Handobukku’ (Carbon Black Handbook) (edited by the Carbon Black Association of Japan).

With regard to the inorganic powder used in the radiation-cured layer, it is possible, as necessary, to use an inorganic powder used in the non-magnetic layer described below.

An additive, solvent, etc. for the inorganic powder can be those described below for the magnetic layer and the non-magnetic layer. In particular, the amounts added and the types of additive and dispersant can be determined according to known technology regarding the magnetic layer.

The addition amount of the above-mentioned inorganic powder and the carbon black is in a range of 50 to 80 parts by weight in terms of the total addition amount of the inorganic powder and carbon black relative to 100 parts by weight of the radiation curing compound, more preferably 10 to 75 parts by weight, and further preferably 15 to 70 parts by weight. The additon amount in the above-mentioned range can give sufficient smoothness, which is preferable.

The ratio of use amount of the inorganic powder and the carbon black is preferably 5 to 95 parts by weight of the carbon black relative to 100 parts by weight of the inorganic powder, more preferably 10 to 90 parts by weight, and further preferably 15 to 80 parts by weight.

<Organic Powder>

The radiation-cured layer used in the present invention may be also incorporated with an organic powder depending on the intended purpose. Examples of the organic powder include an acrylic styrene-based resin powder, a benzoguanamine resin powder, a melamine-based resin powder and a phthalocyanine-based pigment. In addition, a polyolefin-based resin powder, a polyester-based resin powder, a polyamide-based resin powder, a polyimide-based resin powder or a polyethylene fluoride resin powder can be used. The process for producing the same is not particularly limited and those described in, for example, JP-A-62-18564 and JP-A-60-255827 can be used.

<Resin>

The radiation curing compound that can be used for the radiation curing layer may be used in combination with resins described below. Examples of the resin include organic solvent-soluble thermoplastic resins such as polyamide resin, polyamide imide resin, polyester resin, polyurethane resin, vinyl resin and acrylic resin, thermosetting resin, reactive type resin and mixtures thereof.

With regard to the molecular weight of a resin used in combination, a resin having a weight average molecular weight in a range of 1,000 to 100,000 may be preferably used, and in particular, a resin in a range of 5,000 to 50,000 is preferable. A resin having the molecular weight in the above-mentioned range does not bring about blocking at edge face and has good solubility in an organic solvent making it sufficiently possible to coat the radiation curing layer, which is preferable.

When a resin used in combination with a radiation curing compound is used, for example, the resin is added in a range of preferably 5 to 200 parts by weight, more preferably 10 to 100 parts by weight, and particularly preferably 20 to 80 parts by weight relative to 100 parts by weight of the radiation curing compound. When the mixing amount of the resin is in the above-mentioned range, leveling properties that are advantageous to smoothing can be assured and curing shrinkage due to cross-linking can be suppressed, which is preferable.

A composition composed of a radiation curing compound, an additive and the like contained in the radiation curing layer is formed as a coating solution with a solvent capable of dissolving the radiation curing compound. As the solvent, a known one can be used without particular restriction. When a reactive diluent or a resin is used as an additive, use of a solvent that can dissolve these is preferable. The radiation-cured layer used in the present invention may be dried by either natural drying or heating drying. After coating the above-mentioned coating liquid on a non-magnetic support and drying, the above-mentioned radiation is irradiated to the coated layer.

II. Magnetic Layer

II-1. Ferromagnetic Powder

The ferromagnetic powder contained in the magnetic layer of the present invention can be either a ferromagnetic metal powder or a ferromagnetic hexagonal ferrite powder.

<Ferromagnetic Metal Powder>

The ferromagnetic metal powder used in the magnetic layer of the present invention is not particularly limited as long as Fe is contained as a main component (including an alloy), and a ferromagnetic alloy powder having α-Fe as a main component is preferable. These ferromagnetic metal powders may contain, apart from the designated atom, atoms such as Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, and B. It is preferable for the powder to contain, in addition to α-Fe, at least one chosen from Al, Si, Ca, Y, Ba, La, Nd, Co, Ni, and B, and particularly preferably Co, Al, and Y. More specifically, the Co content is preferably 10 to 40 atom % relative to Fe, the Al content is preferably 2 to 20 atom %, and the Y content is preferably 1 to 15 atom %.

These ferromagnetic metal powders may be treated in advance, prior to dispersion, with a dispersant, a lubricant, a surfactant, an antistatic agent, etc., which will be described later. The ferromagnetic metal powder may contain a small amount of water, a hydroxide, or an oxide.

The water content of the ferromagnetic metal powder is preferably set at 0.01 to 2%. The water content of the ferromagnetic metal powder is preferably optimized according to the type of binder.

The crystallite size is preferably 8 to 20 nm, more preferably 10 to 18 nm, and yet more preferably 12 to 16 nm. The crystallite size can be determined by, for example, a method of an average value obtained by the Scherrer method from a half-value width of a diffraction peak obtained using an X-ray diffractometer (RINT2000 series manufactured by Rigaku Corporation) with a CuKα1 radiation source, a tube voltage of 50 kV, and a tube current of 300 mA.

The length of the major axis of the ferromagnetic metal powder is preferably 10 to 100 nm, more preferably 30 to 90 nm, and yet more preferably 40 to 80 nm. When the magnetic recording medium of the present invention is played back using a magnetoresistive head (MR head), the length of the major axis of the ferromagnetic metal powder is preferably 60 nm or less. The length of the major axis is determined by the combined use of a method in which a transmission electron microscope photograph is taken and the length of the minor axis and the length of the major axis of the ferromagnetic metal powder are measured directly therefrom, and a method in which a transmission electron microscope photograph is traced by an IBASSI image analyzer (manufactured by Carl Zeiss Inc.) and read off.

The specific surface area (the BET specific surface area, it is described as ‘S_{BET}’ as abbreviation below) obtained by the BET method of the ferromagnetic metal powder used in the magnetic layer of the present invention is preferably at least 30 m²/g and less than 80 m²/g, and more preferably 38 to 72 m²/g. This enables both good surface properties and low noise to be achieved at the same time. The pH of the ferromagnetic metal powder is preferably optimized according to the binder used in combination therewith. The pH is preferably in the range of 4 to 12, and more preferably from 7 to 10. The ferromagnetic metal powder may be subjected to a surface treatment with Al, Si, P, or an oxide thereof, if necessary. The amount thereof is preferably 0.1 to 10 wt % relative to the ferromagnetic metal powder. The surface treatment can preferably suppress adsorption of a lubricant such as a fatty acid to 100 mg/m² or less.

The ferromagnetic metal powder may contain soluble inorganic ions such as Na, Ca, Fe, Ni or Sr ions in some cases, and their presence at 200 ppm or less does not particularly affect the characteristics. Furthermore, the ferromagnetic metal powder used in the magnetic layer of the present invention preferably has few pores, and the level thereof is preferably 20 vol % or less, and more preferably 5 vol % or less. The form of the ferromagnetic metal powder may be any of acicular, granular, rice-grain shaped, and tabular as long as the above-mentioned requirements for the particle size are satisfied, but it is particularly preferable to use an acicular ferromagnetic metal powder. In the case of the acicular ferromagnetic metal powder, the acicular ratio is preferably 4 to 12, and more preferably 5 to 12.

The coercive force (Hc) of the ferromagnetic metal powder is preferably 159 to 239 kA/m (2,000 to 3,000 Oe), and more preferably 167 to 231 kA/m (2,100 to 2,900 Oe). The saturation magnetic flux density is preferably 150 to 300 mT (1,500 to 3,000 G), and more preferably 160 to 290 mT (1,600 to 2,900 G). The saturation magnetization (σs) is preferably 100 to 170 A·m²/kg (emu/g), and more preferably 100 to 160 A·m²/kg (emu/g).

The SFD (switching field distribution) of the magnetic substance itself is preferably low, and 0.8 or less is preferred. When the SFD is 0.8 or less, the electromagnetic conversion characteristics become good, the output becomes high, the magnetization reversal becomes sharp with a small peak shift, and it is suitable for high-recording-density digital magnetic recording. In order to narrow the Hc distribution, there is a technique of improving the particle distribution of goethite, a technique of using monodispersed α-Fe₂O₃, and a technique of preventing sintering between particles, etc. in the ferromagnetic metal powder.

The ferromagnetic metal powder can be obtained by a known production method and the following methods can be cited. There are a method in which hydrated iron oxide or iron oxide, on which a sintering prevention treatment has been carried out, is reduced with a reducing gas such as hydrogen to give Fe or Fe—Co particles, a method involving reduction with a composite organic acid salt (mainly an oxalate) and a reducing gas such as hydrogen, a method involving thermolysis of a metal carbonyl compound, a method involving reduction by the addition of a reducing agent such as sodium borohydride, a hypophosphite, or hydrazine to an aqueous solution of a ferromagnetic metal, a method in which a fine powder is obtained by vaporizing a metal in an inert gas at low pressure, etc. The ferromagnetic metal powder thus obtained can be subjected to a known slow oxidation process. A method in which hydrated iron oxide or iron oxide is reduced with a reducing gas such as hydrogen, and an oxide film is formed on the surface thereof by controlling the time and the partial pressure and temperature of an oxygen-containing gas and an inert gas is preferable since there is little loss of magnetization.

<Ferromagnetic Hexagonal Ferrite Powder>

Examples of the hexagonal ferrite powder contained in the magnetic layer of the present invention include substitution products of barium ferrite, strontium ferrite, lead ferrite, and calcium ferrite, and Co substitution products. More specifically, magnetoplumbite type barium ferrite and strontium ferrite, magnetoplumbite type ferrite with a particle surface coated with a spinel, magnetoplumbite type barium ferrite and strontium ferrite partially containing a spinel phase, etc., can be cited. It may contain, in addition to the designated atoms, an atom such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, or Zr. In general, those to which Co—Zn, Co—Ti, Co—Ti—Zr, Co—Ti—Zn, Ni—Ti—Zn, Nb—Zn—Co, Sb—Zn—Co, Nb—Zn, etc. have been added can be used. Characteristic impurities may be included depending on the starting material and the production process.

The average plate size of the ferromagnetic hexagonal ferrite powder is preferably in the range of 5 to 40 nm, more preferably 20 to 35 nm, and yet more preferably 20 to 30 nm. When the average plate size of the ferromagnetic hexagonal ferrite powder is in the above-mentioned range, it is preferable that a noise is reduced in playback used by a magnetoresistive head (MR head), and stable magnetization can be expected without the influence of thermal fluctuations.

The tabular ratio (plate size/plate thickness) of the ferromagnetic hexagonal ferrite powder is preferably 1 to 15, and more preferably 1 to 7. If the tabular ratio is small, high packing in the magnetic layer can be obtained, which is preferable, but if it is too small, sufficient orientation cannot be achieved, and it is therefore preferably at least 1. Furthermore, when the tabular ratio is 15 or less, the noise can be suppressed by inter-particle stacking. The specific surface area (S_{BET}) by the BET method of a powder having a particle size within this range is 10 to 200 m²/g. The specific surface area substantially coincides with the value obtained by calculation using the plate size and the plate thickness. The plate size and plate thickness distributions are generally preferably as narrow as possible. Although it is difficult, the distribution can be expressed using a numerical value by randomly measuring 500 particles on a transmission electron microscopy (TEM) photograph of the particles. The distribution is not a regular distribution in many cases, but the standard deviation calculated with respect to the average size is preferably σ/average size=0.1 to 2.0. In order to narrow the particle size distribution, the reaction system used for forming the particles is made as homogeneous as possible, and the particles so formed are subjected to a distribution-improving treatment. For example, a method of selectively dissolving ultrafine particles in an acid solution is also known.

The coercive force (Hc) measured for the ferromagnetic hexagonal ferrite powder can be adjusted so as to be on the order of 39.8 to 398 kA/m (500 to 5,000 Oe). A higher coercive force (Hc) is advantageous for high-density recording, but it is restricted by the capacity of the recording head. The coercive force (Hc) in the present invention is preferably on the order of 159.2 to 238.8 kA/m (2,000 to 3,000 Oe), and more preferably 175.1 to 222.9 kA/m (2,200 to 2,800 Oe). When the saturation magnetization of the head exceeds 1.4 T, it is preferably 159.2 kA/m (2,000 Oe) or higher. The coercive force (Hc) can be controlled by the particle size (plate size, plate thickness), the types and the amount of element included, the element substitution sites, the conditions used for the particle formation reaction, etc. The saturation magnetization (σs) is preferably 40 to 80 A·m²/kg (40 to 80 emu/g). A higher saturation magnetization (σs) is preferable, but there is a tendency for it to become lower when the particles become finer. In order to improve the saturation magnetization (σs), making a composite of magnetoplumbite ferrite with spinel ferrite, selecting the types of element included and their amount, etc., are well known. It is also possible to use a W type hexagonal ferrite in the magnetic layer of the present invention.

When dispersing the ferromagnetic hexagonal ferrite powder, the surface of the magnetic particles can be treated with a material that is compatible with a dispersing medium and a polymer. With regard to a surface-treatment agent, an inorganic or organic compound can be used. Representative examples include compounds of Si, Al, P, etc., and various types of silane coupling agents and various types of titanate coupling agents. The amount thereof added is preferably 0.1 to 10% relative to the magnetic substance. The pH of the magnetic substance is also important for dispersion. It is usually on the order of 4 to 12, and although the optimum value depends on the dispersing medium and the polymer, it is selected from on the order of 6 to 11 from the viewpoints of chemical stability and storage properties of the medium. The moisture contained in the ferromagnetic hexagonal ferrite powder also influences the dispersion. Although the optimum value depends on the dispersing medium and the polymer, it is chosen usually preferably 0.01 to 2.0%.

With regard to the production method for ferromagnetic hexagonal ferrite powder, there is glass crystallization method (1) in which barium oxide, iron oxide, a metal oxide that replaces iron, and boron oxide, etc. as a glass forming material are mixed so as to give a desired ferrite composition, then melted and rapidly cooled to give an amorphous substance, subsequently reheated, then washed, and ground to give a barium ferrite crystal powder; hydrothermal reaction method (2) in which a barium ferrite composition metal salt solution is neutralized with an alkali, and after a by-product is removed, it is heated in a liquid phase at 100° C. or higher, then washed, dried and ground to give a barium ferrite crystal powder; co-precipitation method (3) in which a barium ferrite composition metal salt solution is neutralized with an alkali, and after a by-product is removed, it is dried and treated at 1100° C. or less, and ground to give a barium ferrite crystal powder, etc., but the production method for ferromagnetic hexagonal ferrite powder of the present invention is not particularly limited and any production method can be used. The ferromagnetic hexagonal ferrite powder can be subjected if necessary to a surface treatment with Al, Si, P, an oxide thereof, etc. The amount thereof is preferably 0.1 to 10% based on the ferromagnetic hexagonal ferrite powder, and the surface treatment can reduce the adsorption of a lubricant such as a fatty acid to 100 mg/m² or less, which is preferable. The ferromagnetic hexagonal ferrite powder may contain soluble inorganic ions such as Na, Ca, Fe, Ni or Sr ions in some cases. It is preferable for the soluble inorganic ions to be substantially absent, but their presence at 200 ppm or less does not particularly affect the characteristics.

II-2. Binder

Examples of a binder used in the magnetic layer include a polyurethane resin, a polyester resin, a polyamide resin, a vinyl chloride resin, an acrylic resin obtained by copolymerization of styrene, acrylonitrile, methyl methacrylate, etc., a cellulose resin such as nitrocellulose, an epoxy resin, a phenoxy resin, and a polyvinyl acetal resin such as polyvinyl acetal or polyvinyl butyral, and they can be used singly or in a combination of two or more types. Among these, the polyurethane resin, the acrylic resin, the cellulose resin, and the vinyl chloride resin are preferable.

In order to improve the dispersibility of the powders, the binder preferably has a functional group (polar group) that is adsorbed on the surface of the magnetic powder and the non-magnetic powder. Preferred examples of the functional group include —SO₃M, —SO₄M, —PO(OM)₂, —OPO(OM)₂, —COOM, >NSO₃M, >NRSO₃M, —NR¹R², and —N⁺R¹R²R³X⁻. M denotes a hydrogen atom or an alkali metal such as Na or K, R denotes an alkylene group, R¹, R², and R³ denote alkyl groups, hydroxyalkyl groups, or hydrogen atoms, and X denotes a halogen such as Cl or Br. The amount of functional group in the binder is preferably 10 to 200 μeq/g, and more preferably 30 to 120 μeq/g. When it is in this range, good dispersibility can be achieved, which is preferable.

The binder preferably includes, in addition to the adsorbing functional group, a functional group having an active hydrogen, such as —OH, group in order to improve the coating strength by reacting with an isocyanate curing agent so as to form a crosslinked structure. A preferred amount is 0.1 to 2 meq/g.

The molecular weight of the binder is preferably 10,000 to 200,000 as a weight-average molecular weight, and more preferably 20,000 to 100,000. When it is in this range, sufficient coating strength can be obtained, and both the durability and the dispersibility are good, which is preferable.

The polyurethane resin, which is a preferred binder, is described in detail in, for example, ‘Poriuretan Jushi Handobukku’ (Polyurethane Resin Handbook) (Ed., K. Iwata, 1986, The Nikkan Kogyo Shimbun, Ltd.), and it is normally obtained by addition-polymerization of a long chain diol, a short chain diol (also known as a chain extending agent), and a diisocyanate compound. As the long chain diol, a polyester diol, a polyether diol, a polyetherester diol, a polycarbonate diol, a polyolefin diol, etc, having a molecular weight of 500 to 5,000 are used. Depending on the type of this long chain polyol, the polyurethanes are called polyester urethanes, polyether urethanes, polyetherester urethanes, polycarbonate urethanes, etc.

The polyester diol is obtained by a condensation-polymerization between a glycol and a dibasic aliphatic acid such as adipic acid, sebacic acid, or azelaic acid, or a dibasic aromatic acid such as isophthalic acid, orthophthalic acid, terephthalic acid, or naphthalenedicarboxylic acid. Examples of the glycol component include ethylene glycol, 1,2-propylene glycol, 1,3-propanediol, 1,4-butanediol, 1,5-pentanediol, 3-methyl-1,5-pentanediol, 1,6-hexanediol, 2,2-dimethyl-1,3-propanediol, 1,8-octanediol, 1,9-nonanediol, cyclohexanediol, cyclohexane dimethanol, and hydrogenated bisphenol A. As the polyester diol, in addition to the above, a polycaprolactonediol or a polyvalerolactonediol obtained by ring-opening polymerization of a lactone such as ε-caprolactone or γ-valerolactone can be used.

From the viewpoint of resistance to hydrolysis, the polyester diol is preferably one having a branched side chain or one obtained from an aromatic or alicyclic starting material.

Examples of the polyether diol include polyethylene glycol, polypropylene glycol, polytetramethylene glycol, aromatic glycols such as bisphenol A, bisphenol S, bisphenol P, and hydrogenated bisphenol A, and addition-polymerization products from an alicyclic diol and an alkylene oxide such as ethylene oxide or propylene oxide.

These long chain diols can be used as a mixture of a plurality of types thereof.

The short chain diol can be chosen from the compound group that is cited as the glycol component of the above-mentioned polyester diol. Furthermore, a small amount of a tri- or higher-hydric alcohol such as, for example, trimethylolethane, trimethylolpropane, or pentaerythritol can be added, and this gives a polyurethane resin having a branched structure, thus reducing the solution viscosity and increasing the number of OH end groups of the polyurethane so as to improve the curing properties with the isocyanate curing agent.

Examples of the diisocyanate compound include aromatic diisocyanates such as MDI (diphenylmethane diisocyanate), 2,4-TDI (tolylene diisocyanate), 2,6-TDI, 1,5-NDI (naphthalene diisocyanate), TODI (tolidine diisocyanate), p-phenylene diisocyanate, and XDI (xylylene diisocyanate), and aliphatic and alicyclic diisocyanates such as trans-cyclohexane-1,4-diisocyanate, HDI (hexamethylene diisocyanate), IPDI (isophorone diisocyanate), H₆XDI (hydrogenated xylylene diisocyanate), and H₁₂MDI (hydrogenated diphenylmethane diisocyanate).

The long chain diol/short chain diol/diisocyanate ratio in the polyurethane resin is preferably (15 to 80 wt %)/(5 to 40 wt %)/(15 to 50 wt %).

The concentration of urethane groups in the polyurethane resin is preferably 1 to 5 meq/g, and more preferably 1.5 to 4.5 meq/g. When it is in this range, the mechanical strength is high, and since the solution viscosity is good high dispersibility can be obtained, which is preferable.

The glass transition temperature of the polyurethane resin is preferably 0 to 200° C., and more preferably 40 to 160° C. When it is in this range, the durability is excellent, the calender moldability is good, and good electromagnetic conversion characteristics can therefore be obtained, which is preferable.

With regard to a method for introducing the adsorbing functional group (polar group) into the polyurethane resin, there are, for example, a method in which the functional group is used in a part of the long chain diol monomer, a method in which it is used in a part of the short chain diol, and a method in which, after the polyurethane is formed by polymerization, the polar group is introduced by a polymer reaction.

As the vinyl chloride resin a copolymer of a vinyl chloride monomer and various types of monomer is used.

Examples of the comonomer include fatty acid vinyl esters such as vinyl acetate and vinyl propionate, acrylates and methacrylates such as methyl(meth)acrylate, ethyl(meth)acrylate, isopropyl(meth)acrylate, butyl(meth)acrylate, and benzyl(meth)acrylate, alkyl allyl ethers such as allyl methyl ether, allyl ethyl ether, allyl propyl ether, and allyl butyl ether, and others such as styrene, α-methylstyrene, vinylidene chloride, acrylonitrile, ethylene, butadiene, and acrylamide; examples of a comonomer having a functional group include vinyl alcohol, 2-hydroxyethyl(meth)acrylate, polyethylene glycol(meth)acrylate, 2-hydroxypropyl(meth)acrylate, 3-hydroxypropyl(meth)acrylate, polypropylene glycol(meth)acrylate, 2-hydroxyethyl allyl ether, 2-hydroxypropyl allyl ether, 3-hydroxypropyl allyl ether, p-vinylphenol, maleic acid, maleic anhydride, acrylic acid, methacrylic acid, glydicyl(meth)acrylate, allyl glycidyl ether, phosphoethyl(meth)acrylate, sulfoethyl(meth)acrylate, p-styrenesulfonic acid, and Na salts and K salts thereof.

The proportion of the vinyl chloride monomer in the vinyl chloride resin is preferably 60 to 95 wt %. When it is less than this range the mechanical strength deteriorates, and when it is too high the solvent solubility is degraded, the solution viscosity increases, and the dispersibility deteriorates.

A preferred amount of a functional group for improving the curing properties of the adsorbing functional group (polar group) and the polyisocyanate curing agent is as described above. With regard to a method for introducing this functional group, a monomer containing the above-mentioned functional group can be copolymerized, or after the vinyl chloride resin is formed by copolymerization, the functional group can be introduced by a polymer reaction.

A preferred degree of polymerization is 200 to 600, and more preferably 240 to 450. When it is in this range, the mechanical strength is high, the solution viscosity is good, and the dispersibility is high, which is preferable.

In order to crosslink and cure the binder so as to improve the mechanical strength and the thermal resistance of a coating, a curing agent can be used in the magnetic layer in the present invention. Preferred examples of the curing agent include polyisocyanate compounds. It is preferable for the polyisocyanate compound to be a tri- or higher-functional polyisocyanate.

Specific examples thereof include adduct type polyisocyanate compounds such as a compound obtained by adding 3 mol of TDI (tolylene diisocyanate) to 1 mol of trimethylolpropane (TMP), a compound obtained by adding 3 mol of HDI (hexamethylene diisocyanate) to 1 mol of TMP, a compound obtained by adding 3 mol of IPDI (isophorone diisocyanate) to 1 mol of TMP, and a compound obtained by adding 3 mol of XDI (xylylene diisocyanate) to 1 mol of TMP; TDI condensation isocyanurate type trimer, TDI condensation isocyanurate type pentamer; TDI condensation isocyanurate type heptamer, mixtures thereof; an HDI isocyanurate type condensate, an IPDI isocyanurate type condensate; and crude MDI.

Among these, the compound obtained by adding 3 mol of TDI to 1 mol of TMP, TDI isocyanurate type trimer, etc. are preferable.

Other than the isocyanate curing agents, a curing agent that cures when exposed to an electron beam, ultraviolet rays, etc. can be used. In this case, it is possible to use a curing agent having, as radiation-curing functional groups, two or more, and preferably three or more, acryloyl or methacryloyl groups. Examples thereof include TMP (trimethylolpropane) triacrylate, pentaerythritol tetraacrylate, and a urethane acrylate oligomer. In this case, it is preferable to introduce a (meth)acryloyl group not only to the curing agent but also to the binder. In the case of curing with ultraviolet rays, a photosensitizer is additionally used.

It is preferable to add 0 to 80 parts by weight of the curing agent relative to 100 parts by weight of the binder. When it is in this range, it is preferable that the dispersibility is good.

The amount of binder added to the magnetic layer is preferably 5 to 30 parts by weight relative to 100 parts by weight of the ferromagnetic powder, and more preferably 10 to 20 parts by weight.

II-3. Additive

The magnetic layer of the present invention can contain an additive as necessary. Examples of the additive include an abrasive, a lubricant, a dispersant/dispersion adjuvant, an anti-mold agent, an antistatic agent, an antioxidant, a solvent, and carbon black.

Examples of these additives are as follows.

Molybdenum disulfide, tungsten disulfide, graphite, boron nitride, graphite fluoride, a silicone oil, a polar group-containing silicone, a fatty acid-modified silicone, a fluorine-containing silicone, a fluorine-containing alcohol, a fluorine-containing ester, a polyolefin, a polyglycol, a polyphenyl ether, and aromatic ring-containing organic phosphonic acids such as phenylphosphonic acid, benzylphosphonic acid, phenethylphosphonic acid, α-methylbenzylphosphonic acid, 1-methyl-1-phenethylphosphonic acid, diphenylmethylphosphonic acid, biphenylphosphonic acid, benzylphenylphosphonic acid, α-cumylphosphonic acid, tolylphosphonic acid, xylylphosphonic acid, ethylphenylphosphonic acid, cumenylphosphonic acid, propylphenylphosphonic acid, butylphenylphosphonic acid, heptylphenylphosphonic acid, octylphenylphosphonic acid, nonylphenylphosphonic acid, and alkali metal salts thereof; alkylphosphonic acids such as octylphosphonic acid, 2-ethylhexylphosphonic acid, isooctylphosphonic acid, isononylphosphonic acid, isodecylphosphonic acid, isoundecylphosphonic acid, isododecylphosphonic acid, isohexadecylphosphonic acid, isooctadecylphosphonic acid, and isoeicosylphosphonic acid, and alkali metal salts thereof; aromatic phosphates such as phenyl phosphate, benzyl phosphate, phenethyl phosphate, α-methylbenzyl phosphate, 1-methyl-1-phenethyl phosphate, diphenylmethyl phosphate, biphenyl phosphate, benzylphenyl phosphate, α-cumyl phosphate, tolyl phosphate, xylyl phosphate, ethylphenyl phosphate, cumenyl phosphate, propylphenyl phosphate, butylphenyl phosphate, heptylphenyl phosphate, octylphenyl phosphate, and nonylphenyl phosphate, and alkali metal salts thereof; alkyl phosphates such as octyl phosphate, 2-ethylhexyl phosphate, isooctyl phosphate, isononyl phosphate, isodecyl phosphate, isoundecyl phosphate, isododecyl phosphate, isohexadecyl phosphate, isooctadecyl phosphate, and isoeicosyl phosphate, and alkali metal salts thereof; alkyl sulphonates and alkali metal salts thereof; fluorine-containing alkyl sulfates and alkali metal salts thereof; monobasic fatty acids that have 10 to 24 carbons, may contain an unsaturated bond, and may be branched, such as lauric acid, myristic acid, palmitic acid, stearic acid, behenic acid, butyl stearate, oleic acid, linoleic acid, linolenic acid, elaidic acid, or erucic acid, and metal salts thereof; mono-fatty acid esters, di-fatty acid esters, and poly-fatty acid esters such as butyl stearate, octyl stearate, amyl stearate, isooctyl stearate, octyl myristate, butyl laurate, butoxyethyl stearate, anhydrosorbitan monostearate, anhydrosorbitan distearate, and anhydrosorbitan tristearate that are formed from a monobasic fatty acid that has 10 to 24 carbons, may contain an unsaturated bond, and may be branched, and any one of a mono- to hexa-hydric alcohol that has 2 to 22 carbons, may contain an unsaturated bond, and may be branched, an alkoxy alcohol that has 12 to 22 carbons, may have an unsaturated bond, and may be branched, and a mono alkyl ether of an alkylene oxide polymer; fatty acid amides having 2 to 22 carbons; aliphatic amines having 8 to 22 carbons; etc. Other than the above-mentioned hydrocarbon groups, those having an alkyl, aryl, or aralkyl group that is substituted with a group other than a hydrocarbon group, such as a nitro group, F, Cl, Br, or a halogen-containing hydrocarbon such as CF₃, CCl₃, or CBr₃ can also be used.

Furthermore, there are a nonionic surfactant such as an alkylene oxide type, a glycerol type, a glycidol type, or an alkylphenol-ethylene oxide adduct; a cationic surfactant such as a cyclic amine, an ester amide, a quaternary ammonium salt, a hydantoin derivative, a heterocyclic compound, a phosphonium salt, or a sulfonium salt; an anionic surfactant containing an acidic group such as a carboxylic acid, a sulfonic acid, or a sulfate ester group; and an amphoteric surfactant such as an amino acid, an aminosulfonic acid, a sulfate ester or a phosphate ester of an amino alcohol, or an alkylbetaine. Details of these surfactants are described in ‘Kaimenkasseizai Binran’ (Surfactant Handbook) (published by Sangyo Tosho Publishing).

The dispersant, lubricant, etc. need not always be pure and may contain, in addition to the main component, an impurity such as an isomer, an unreacted material, a by-product, a decomposed product, or an oxide. However, the impurity content is preferably 30 wt % or less, and more preferably 10 wt % or less.

Specific examples of these additives include NAA-102, hardened castor oil fatty acids, NAA-42, Cation SA, Nymeen L-201, Nonion E-208, Anon BF, and Anon LG, (produced by Nippon Oil & Fats Co., Ltd.); FAL-205, and FAL-123 (produced by Takemoto Oil & Fat Co., Ltd), Enujelv OL (produced by New Japan Chemical Co., Ltd.), TA-3 (produced by Shin-Etsu Chemical Industry Co., Ltd.), Armide P (produced by Lion Armour), Duomin TDO (produced by Lion Corporation), BA-41G (produced by The Nisshin Oil Mills, Ltd.), Profan 2012E, Newpol PE 61, and Ionet MS-400 (produced by Sanyo Chemical Industries, Ltd.).

An organic solvent used for the magnetic layer of the present invention can be a known organic solvent. As the organic solvent, a ketone such as acetone, methyl ethyl ketone, methyl isobutyl ketone, diisobutyl ketone, cyclohexanone, or isophorone, an alcohol such as methanol, ethanol, propanol, butanol, isobutyl alcohol, isopropyl alcohol, or methylcyclohexanol, an ester such as methyl acetate, butyl acetate, isobutyl acetate, isopropyl acetate, ethyl lactate, or glycol acetate, a glycol ether such as glycol dimethyl ether, glycol monoethyl ether, or dioxane, an aromatic hydrocarbon such as benzene, toluene, xylene, or cresol, a chlorohydrocarbon such as methylene chloride, ethylene chloride, carbon tetrachloride, chloroform, ethylene chlorohydrin, chlorobenzene, or dichlorobenzene, N,N-dimethylformamide, hexane, tetrahydrofuran etc. can be used at any ratio.

These organic solvents do not always need to be 100% pure, and may contain an impurity such as an isomer, an unreacted compound, a by-product, a decomposed product, an oxide, or moisture in addition to the main component. The content of these impurities is preferably 30% or less, and more preferably 10% or less.

When a non-magnetic layer is provided, the organic solvent used in the present invention is preferably the same type for both the magnetic layer and the non-magnetic layer. However, the amount added may be varied. The coating stability is improved by using a high surface tension solvent (cyclohexanone, dioxane, etc.) for the non-magnetic layer; more specifically, it is important that the arithmetic mean value of the surface tension of the magnetic layer solvent composition is not less than that for the surface tension of the non-magnetic layer solvent composition. In order to improve the dispersibility, it is preferable for the polarity to be somewhat strong, and the solvent composition preferably contains at least 50% of a solvent having a permittivity of 15 or higher. The solubility parameter is preferably 8 to 11.

The type and the amount of the dispersant, lubricant, and surfactant used in the magnetic layer of the present invention can be changed as necessary in the magnetic layer and the non-magnetic layer, which will be described later. For example, although not limited to only the examples illustrated here, the dispersant has the property of adsorbing or bonding via its polar group, and it is surmised that the dispersant adsorbs or bonds, via the polar group, to mainly the surface of the ferromagnetic powder in the magnetic layer and mainly the surface of the non-magnetic powder in the non-magnetic layer, which will be described later, and once adsorbed it is hard to desorb the dispersant, especially an organophosphorus compound, from the surface of metal, a metal compound, etc. Therefore, since in the present invention the surface of the ferromagnetic powder or the surface of the non-magnetic powder, which will be described later, are in a state in which they are covered with an alkyl group, an aromatic group, etc., the affinity of the ferromagnetic powder or the non-magnetic powder toward the binder resin component increases and, furthermore, the dispersion stability of the ferromagnetic powder or the non-magnetic powder is also improved. With regard to the lubricant, since it is present in a free state, its exudation to the surface is controlled by using fatty acids having different melting points for the non-magnetic layer and the magnetic layer or by using esters having different boiling points or polarity. The coating stability can be improved by regulating the amount of surfactant added, and the lubrication effect can be improved by increasing the amount of lubricant added to the non-magnetic layer. All or a part of the additives used in the present invention may be added to magnetic layer or non-magnetic layer coating solutions at any stage of their preparation. For example, an additive may be blended with a ferromagnetic powder before a kneading step; it may be added during a kneading step involving the ferromagnetic powder, a binder, and a solvent; it may be added during a dispersing step; it may be added after the dispersing step; or it may be added immediately before coating.

The magnetic layer in the present invention can contain carbon black as necessary.

The carbon black used in the magnetic layer can be the same as that used in the radiation-cured layer. The carbon black may be used singly or in a combination. When carbon black is used, the amount thereof added is preferably 0.1 to 30 wt % relative to the magnetic substance. The carbon black has the functions of preventing static charging of the magnetic layer, reducing the coefficient of friction, imparting light-shielding properties, and improving the coating strength. Such functions vary depending upon the type of carbon black used. Accordingly, it is of course possible in the present invention to appropriately choose the type, the amount, and the combination of carbon black for the magnetic layer according to the intended purpose on the basis of the above-mentioned various properties such as the particle size, the oil absorption, the electrical conductivity and the pH value, but it is better if they are optimized for the respective layers.

III. Non-Magnetic Support

With regard to the non-magnetic support that can be used in the present invention, known biaxially stretched films such as polyethylene terephthalate, polyethylene naphthalate, polyamide, polyamideimide, and aromatic polyamide can be used. Polyethylene terephthalate, polyethylene naphthalate, and polyamide are preferred.

These supports can be subjected in advance to a corona discharge treatment, a plasma treatment, a treatment for enhancing adhesion, a thermal treatment, etc. The non-magnetic support that can be used in the present invention preferably has a surface smoothness such that its center plane average surface roughness Ra is in the range of 3 to 10 nm for a cutoff value of 0.25 mm.

IV. Non-Magnetic Layer

The magnetic recording medium of the present invention can include a non-magnetic layer above the non-magnetic support, the non-magnetic layer containing a binder and a non-magnetic powder. The non-magnetic powder that can be used in the non-magnetic layer can be an inorganic substance or an organic substance. The non-magnetic layer can further include carbon black as necessary together with the non-magnetic powder.

In general, the light transmittance of the non-magnetic layer of the present invention is preferably 3% or less for infrared rays having a wavelength of about 900 nm. The micro Vickers hardness is preferably 25 to 60 kg/mm² and, for adjusting the head contact, more preferably 30 to 50 kg/mm². It can be measured using a thin film hardness meter (HMA-400 manufactured by NEC Corporation) with a four-sided pyramidal diamond probe having a tip angle of 800 and a tip radius of 0.1 μm.

The carbon black and the non-magnetic powder of the non-magnetic layer can be the same as those used for the radiation-cured layer. The carbon black can be used singly or in a combination. When carbon black is used, the amount thereof added is preferably 0.1 to 1,000 wt % relative to the non-magnetic powder. The carbon black has the functions of preventing static charging, reducing the coefficient of friction, imparting light-shielding properties, improving the coating strength, etc. of the non-magnetic layer, and these functions depend on the type of carbon black. Therefore, the type, the amount, and the combination of carbon black used in the present invention can of course be determined for the non-magnetic layer according to the intended purpose based on the above-mentioned various properties such as the particle size, the oil absorption, the electric conductivity, and the pH, but it is better if they are optimized for each layer.

As a binder resin, lubricant, dispersant, additive, solvent, dispersing method, etc. for the non-magnetic layer, those for the magnetic layer can be employed. In particular, the amount and the type of binder, and the amounts and types of additive and dispersant can be determined according to known techniques regarding the magnetic layer.

V. Backcoat Layer

In general, there is a strong requirement for magnetic tapes for recording computer data to have better repetitive transport properties than video tapes and audio tapes. In order to maintain such high storage stability, a backcoat layer can be provided on the surface of the non-magnetic support opposite to the surface where the non-magnetic layer and the magnetic layer are provided. As a coating solution for the backcoat layer, a binder and a particulate component such as an abrasive or an antistatic agent are dispersed in an organic solvent. As a particulate component, various types of inorganic pigment or carbon black can be used. As the binder, a resin such as nitrocellulose, a phenoxy resin, a vinyl chloride resin, or a polyurethane can be used singly or in combination.

VI. Undercoat Layer

In the magnetic recording medium of the present invention, an undercoat layer can be further provided between the non-magnetic support and the radiation-cured layer. Providing the undercoat layer enables the adhesion between the non-magnetic support and the radiation-cured layer to be improved. In the undercoat layer, a solvent-soluble polyester resin, polyurethane resin, polyamide resin, or polyamideimide resin, etc. can be used. The thickness of the undercoat layer is preferably 0.2 μm.

VII. Layer Structure

In the constitution of the magnetic recording medium used in the present invention, the thickness of the respective radiation-cured layers is preferably 0.05 to 1.0 μm, and more preferably 0.1 to 0.5 μm. There exist preferably 2 or more radiation-cured layers, preferably 2 to 4 layers, more preferably 2 or 3 layers, and particularly preferably 3 layers. The total thickness obtained by summing each thickness of all the radiation-cured layers is preferably 0.15 to 3.0 μm, and more preferably 0.3 to 1.5 μm. The thickness of the non-magnetic support is preferably 3 to 80 μm, and more preferably 3 to 10 μm. When the undercoat layer is provided between the non-magnetic support and the radiation-cured layer, the thickness of the undercoat layer is preferably 0.01 to 0.8 μm, and more preferably 0.02 to 0.6 μm. The thickness of the backcoat layer provided on the surface of the non-magnetic support opposite to the surface where the radiation-cured layer and the magnetic layer are provided is preferably 0.1 to 1.0 μm, and more preferably 0.2 to 0.8 μm.

The thickness of the magnetic layer is optimized according to the saturation magnetization and the head gap length of the magnetic head and the bandwidth of the recording signal but, it is preferably 0.01 to 0.20 μm, more preferably 0.02 to 0.20 μm, yet more preferably 0.02 to 0.12 μm, particularly preferably 0.03 to 0.12 μm. The percentage variation in thickness of the magnetic layer is preferably ±50% or less, and more preferably ±40% or less. The magnetic layer can be at least one layer, but it is also possible to provide two or more separate layers having different magnetic properties, and a known configuration for a multilayer magnetic layer can be employed.

The thickness of the non-magnetic layer is preferably 0.2 to 3.0 μm, more preferably 0.3 to 2.5 μm, and yet more preferably 0.4 to 2.0 μm. The non-magnetic layer of the magnetic recording medium of the present invention can exhibit its effect if it is substantially non-magnetic, but even if a small amount of a magnetic substance is included as an impurity or intentionally, the effects of the present invention are exhibited, and this is considered to have substantially the same constitution as that of the magnetic recording medium of the present invention. The ‘substantially the same’ referred to here means that the residual magnetic flux density of the non-magnetic layer is 10 mT (100 G) or less or the coercive force thereof is 7.96 kA/m (100 Oe) or less, and that it preferably has no residual magnetic flux density or coercive force.

VIII. Production Method

A process for producing the magnetic recording medium of the present invention preferably includes the steps of coating a radiation curing compound-containing layer above a non-magnetic support and curing the same by exposure to radiation to form a first radiation-cured layer, and coating a radiation curing compound-containing layer above the first radiation-cured layer and curing the same by exposure to radiation to form a second radiation-cured layer.

In the present invention, the phrase ‘above a non-magnetic support’ or ‘above a first radiation-cured layer’ does not require that the first radiation-cured layer is in contact with the non-magnetic support or that the second radiation-cured layer is in contact with the first radiation-cured layer. The first radiation-cured layer may be provided above the non-magnetic support via any other intervening layer, and the second radiation-cured layer may be provided above the first radiation-cured layer via any other intervening layer.

When the magnetic recording medium of the present invention includes 2 radiation-cured layers, it is preferable to form a first radiation-cured layer on a non-magnetic support, and then, coat: a radiation curing compound-containing layer on the first radiation-cured layer and cure the same by exposure to radiation. When n-th (n is an integer of 3 or more) radiation-cured layers are included, with regard to a third and subsequent layers, it is preferable to form a (n−1)th radiation-cured layer, and then coat a radiation curing compound-containing layer on the (n−1)th radiation-cured layer and cure the same by exposure to radiation to form nth radiation-cured layer.

The composition and thickness of the first, second and n-th radiation-cured layers may be different from or identical to one another.

As a method for curing the radiation curing compound-containing layer by exposure to radiation, the method described in I-2 above may be used preferably.

A method for producing a magnetic layer coating solution for the magnetic recording medium used in the present invention comprises preferably at least a kneading step, a dispersion step and, optionally, a blending step that is carried out prior to and/or subsequent to the above-mentioned steps. Each of these steps may be composed of two or more separate stages. All materials including the ferromagnetic hexagonal ferrite powder, the ferromagnetic metal powder, the non-magnetic powder, the benzenephosphorous acid derivative, the π-electron conjugatitve type electro-conjugative polymer, the binder, the carbon black, the abrasive, the antistatic agent, the lubricant, and the solvent used in the present invention may be added in any step from the beginning or during the course of the step. The addition of each material may be divided across two or more steps. For example, a polyurethane can be divided and added in a kneading step, a dispersing step, and a blending step for adjusting the viscosity after dispersion. To attain the object of the present invention, a conventionally known production technique may be employed as a part of the steps. In the kneading step, it is preferable to use a powerful kneading machine such as an open kneader, a continuous kneader, a pressure kneader, or an extruder. When such a kneader is used, all or a part of the binder (preferably 30 wt % or above of the entire binder) is preferably kneaded with the ferromagnetic powder. The proportion of the binder added is preferably 5 to 500 parts by weight relative to 100 parts by weight of the ferromagnetic powder. Details of these kneading treatments are described in JP-A-1-106338 and JP-A-1-79274. For the dispersion of the magnetic layer solution and a non-magnetic layer solution, glass beads can be used. As such glass beads, a dispersing medium having a high specific gravity such as zirconia beads, titania beads, or steel beads is suitably used. An optimal particle size and packing density of these dispersing media should be selected. A known dispersing machine can be used.

The process for producing the magnetic recording medium of the present invention containing, for example, two radiation-cured layers includes the steps of coating the surface of a traveling non-magnetic support with a radiation curing layer coating solution so as to give a predetermined coating thickness, and curing the coated layer by exposure to radiation to form a first radiation-cured layer. Then, a radiation curing layer coating solution is coated on the first radiation-cured layer so as to give a predetermined coating thickness, which is cured by exposure to radiation to form a second radiation-cured layer. In addition, a magnetic layer coating solution is coated on the second radiation-cured layer so as to give a predetermined coating thickness. A plurality of radiation curing layer coating solutions may be applied successively or simultaneously, but successive formation of radiation-cured layers as described above is preferable. Also, a plurality of magnetic layer coating solutions can be applied successively or simultaneously, and in this case a lower magnetic layer coating solution and an upper magnetic layer coating solution can be applied successively or simultaneously. As coating equipment for coating the radiation curing layer and magnetic layer coating solutions, an air doctor coater, a blade coater, a rod coater, an extrusion coater, an air knife coater, a squeegee coater, a dip coater, a reverse roll coater, a transfer roll coater, a gravure coater, a kiss coater, a cast coater, a spray coater, a spin coater, etc. can be used. With regard to these, for example, ‘Saishin Kotingu Gijutsu’ (Latest Coating Technology) (May 31, 1983) published by Sogo Gijutsu Center can be referred to.

In the case of a magnetic tape, the coated layer of the magnetic layer coating solution is subjected to a magnetic alignment treatment in which the ferromagnetic powder contained in the coated layer of the magnetic layer coating solution is aligned in the longitudinal direction using a cobalt magnet or a solenoid. In the case of a disk, although sufficient isotropic alignment can sometimes be obtained without using an alignment device, it is preferable to employ a known random alignment device such as, for example, arranging obliquely alternating cobalt magnets or applying an alternating magnetic field with a solenoid. The isotropic alignment referred to here means that, in the case of a ferromagnetic metal powder, in general, in-plane two-dimensional random is preferable, but it can be three-dimensional random by introducing a vertical component. In the case of a ferromagnetic hexagonal ferrite powder, in general, it tends to be in-plane and vertical three-dimensional random, but in-plane two-dimensional random is also possible. By using a known method such as magnets having different poles facing each other so as to make vertical alignment, circumferentially isotropic magnetic properties can be introduced. In particular, when carrying out high density recording, vertical alignment is preferable. Furthermore, circumferential alignment may be employed using spin coating.

It is preferable for the drying position for the coating to be controlled by controlling the drying temperature and blowing rate and the coating speed; it is preferable for the coating speed to be 20 to 1,000 m/min and the temperature of drying air to be at least 60° C., and an appropriate level of pre-drying may be carried out prior to entering a magnet zone.

After drying is carried out, the coated layer is subjected to a surface smoothing treatment. The surface smoothing treatment employs, for example, super calender rolls, etc. By carrying out the surface smoothing treatment, cavities formed by removal of the solvent during drying are eliminated, thereby increasing the packing ratio of the ferromagnetic powder in the magnetic layer, and a magnetic recording medium having high electromagnetic conversion characteristics can thus be obtained.

With regard to calendering rolls, rolls of a heat-resistant plastic such as epoxy, polyimide, polyamide, or polyamideimide are used. It is also possible to treat with metal rolls. The magnetic recording medium of the present invention preferably has a center plane average surface roughness in the range of 0.1 to 4.0 nm for a cutoff value of 0.25 mm, and more preferably 0.5 to 3.0 nm, which is extremely smooth. As a method therefor, a magnetic layer formed by selecting a specific ferromagnetic powder and binder as described above is subjected to the above-mentioned calendering treatment. With regard to a condition of the calender treatment, the calender roll temperature is preferably in the range of 60 to 100° C., more preferably in the range of 70 to 100° C., and particularly preferably in the range of 80 to 100° C., and the pressure is preferably in the range of 100 to 500 kg/cm, more preferably in the range of 200 to 450 kg/cm, and particularly preferably in the range of 300 to 400 kg/cm. The calendering is preferably carried out by operation at a temperature and pressure in the above-mentioned ranges.

As thermal shrinkage reducing means, there is a method in which a web is thermally treated while handling it with low tension, and a method (thermal treatment) involving thermal treatment of a tape when it is in a layered configuration such as in bulk or installed in a cassette, and either can be used. In the former method, the effect of the imprint of projections of the surface of the backcoat layer is small, but the thermal shrinkage cannot be greatly reduced. On the other hand, the latter thermal treatment can improve the thermal shrinkage greatly, but if the effect of the imprint of projections of the surface of the backcoat layer is strong, the surface of the magnetic layer roughens, and there is a possibility that this will cause the output to decrease and the noise to increase. In particular, a high output and low noise magnetic recording medium can be provided for the magnetic recording medium accompanying the thermal treatment. The magnetic recording medium thus obtained can be cut to a desired size using a cutter, a stamper, etc. before use.

IX. Physical Properties

The saturation magnetic flux density of the magnetic layer of the magnetic recording medium used in the present invention is preferably 100 to 300 mT (1,000 to 3,000 G). The coercive force (Hc) of the magnetic layer is preferably 143.3 to 318.4 kA/m (1,800 to 4,000 Oe), and more preferably 159.2 to 278.6 kA/m (2,000 to 3,500 Oe). It is preferable for the distribution of the coercive force to be narrow, and the SFD and SFDr are preferably 0.6 or less, and more preferably 0.2 or less.

The coefficient of friction, with respect to the head, of the magnetic recording medium used in the present invention is preferably 0.5 or less at a temperature of −10° C. to 40° C. and a humidity of 0 to 95%, and preferably 0.4 or less. The electrostatic potential is preferably −500 to +500 V. The modulus of elasticity of the magnetic layer at an elongation of 0.5% is preferably 0.98 to 19.6 GPa (100 to 2,000 kg/mm²) in each direction within the plane, the breaking strength is preferably 98 to 686 MPa (10 to 70 kg/mm²); the modulus of elasticity of the magnetic recording medium is preferably 0.98 to 14.7 GPa (100 to 1,500 kg/mm²) in each direction within the plane, the residual elongation is preferably 0.5% or less, and the thermal shrinkage at any temperature up to and including 100° C. is preferably 1% or less, more preferably 0.5% or less, and yet more preferably 0.1% or less.

The glass transition temperature of the magnetic layer (the maximum point of the loss modulus in a dynamic viscoelasticity measurement measured at 110 Hz) is preferably 50 to 180° C., and that of the non-magnetic layer is preferably 0 to 180° C. The loss modulus is preferably in the range of 1×10⁷ to 8×10⁸ Pa (1×10⁸ to 8×10⁹ dyne/cm²), and the loss tangent is preferably 0.2 or less. When the loss tangent is too large, the problem of tackiness easily occurs. These thermal properties and mechanical properties are preferably substantially identical to within 10% in each direction in the plane of the medium.

The residual solvent in the magnetic layer is preferably 100 mg/m² or less, and more preferably 10 mg/m² or less. The porosity of the coating layer is preferably 30 vol % or less for both the non-magnetic layer and the magnetic layer, and more preferably 20 vol % or less. In order to achieve a high output, the porosity is preferably small, but there are cases in which a certain value should be maintained depending on the intended purpose. For example, in the case of disk media where repetitive use is considered to be important, a large porosity is often preferable from the point of view of storage stability.

With regard to surface roughness of respective layers, an AFM (atomic force microscope) may be used to determine the center line average surface roughness Ra (nm). In the case of the radiation-cured layer, a sample is collected after exposure to radiation without application of subsequent layers, and the surface of the sample is then subjected to an AFM determination to give the center line average surface roughness Ra (nm).

When the magnetic recording medium has a non-magnetic layer, it can easily be anticipated that the physical properties of the non-magnetic layer and the magnetic layer can be varied according to the intended purpose. For example, the elastic modulus of the magnetic layer can be made high, thereby improving the storage stability, and at the same time the elastic modulus of the non-magnetic layer can be made lower than that of the magnetic layer, thereby improving contact of the magnetic recording medium with a head.

A head used for playback of signals recorded magnetically on the magnetic recording medium of the present invention is not particularly limited, but an MR head is preferably used. When an MR head is used for playback of the magnetic recording medium of the present invention, the MR head is not particularly limited and, for example, a GMR head or a TMR head can be used. A head used for magnetic recording is not particularly limited, but it is preferable for the saturation magnetization to be 1.0 T or more, and preferably 1.5 T or more.

In accordance with the present invention, a magnetic recording medium, in which the extremely excellent smooth surface of the magnetic layer is realized and the electromagnetic conversion characteristic is improved, can be provided.

### EXAMPLES

The present invention is explained specifically below with reference to examples. ‘Parts’ in the Examples denotes ‘parts by weight’.

### Example 1

<Preparation of First and Second Radiation Curing Layer Coating Solutions>

A urethane acrylate oligomer A (HEA/MDI/PPG600/MDI/HEA) (HEA: hydroxyethyl acrylate, MDI: diphenylmethane diisocyanate, PPG600: polypropyrene glycol (moleculare weight: about 600)) as a radiation curing compound and a mixed solvent of methyl ethyl ketone/toluene=7/3 as a solvent were stirred and mixed so as to give 10% solution of the urethane acrylate oligomer A to prepare a first radiation curing layer coating solution.

A second radiation curing layer coating solution was prepared in the same way as above.

<Preparation of Third Radiation Curing Layer Coating Solution>

| | | |
|---|---|---|
| Acicular α-iron oxide (major axis length 100 nm, | | |
| surface-treated layer: | | |
| alumina, S_{BET}: 52 m²/g, pH 9.4) | 80 | parts, and |
| carbon black ‘Ketjen black EC’ (manufactured | 20 | parts |
| by Ketjen Black International) | | |
| were ground in an open kneader for 10 minutes, | | |
| subsequently a 30% cyclohexanone solution of a | | |
| vinyl chloride resin MR110 manufactured | | |
| by Nippon Zeon Corporation | 30 | parts, and |
| methyl ethyl ketone | 30 | parts |
| were added and kneaded for 60 minutes, | | |
| methyl ethyl ketone | 200 | parts |
| was further added thereto, and the mixture was | | |
| dispersed in a sand mill for 120 minutes, | | |
| urethane acrylate oligomer A | 100 | parts, |
| dipentaerythritol hexaacrylate (DPHA) | 100 | parts, |
| 2-ethylhexyl stearate | 1 | part, |
| isohexadecyl stearate | 1 | part, |
| stearic acid | 1 | part, |
| myristic acid | 1 | part, |
| methyl ethyl ketone | 100 | parts, and |
| toluene | 100 | parts |
| were further added thereto and stirred and mixed for | | |
| additional 20 minutes, and filtered using a filter | | |
| having an average pore size of 1 μm to give a third | | |
| radiation curing layer coating solution. | | |

<Preparation of Magnetic Coating Solution>

| | | |
|---|---|---|
| 100 parts of a ferromagnetic metal powder (composition: Fe 100 atm %, | | |
| Co 20 atm %, Al 9 atm %, Y 6 atm %, Hc 175 kA/m (2,200 Oe), | | |
| crystallite size 11 nm, S_{BET} 70 m²/g, major axis length | | |
| 45 nm, σs 111 A · m²/kg (emu/g)) was | | |
| ground in an open kneader for 10 minutes, subsequently | | |
| a 30% cyclohexanone solution of a vinyl chloride resin MR110 | 30 | parts, and |
| manufactured by Nippon Zeon Corporation | | |
| a 30% methyl ethyl ketone (MEK)/toluene solution of polyurethane | 30 | parts |
| UR8200 (manufactured by TOYOBO., LTD.) | | |
| were further added thereto and kneaded for 60 minutes, | | |
| an abrasive (Al₂ O₃: particle size 0.1 μm) | 2 | parts, |
| carbon black (particle size 40 μm) | 2 | parts, |
| methyl ethyl ketone | 100 | parts, and |
| toluene | 100 | parts |
| were further added and dispersed in a sand mill for 120 minutes, | | |
| polyisocyanate (Coronate 3041, 30% methyl ethyl ketone solution, | 15 | parts, |
| manufactured by Nippon Polyurethane Industry Co., Ltd.) | | |
| 2-ethylhexyl stearate | 1 | part, |
| isohexadecyl stearate | 1 | part, |
| stearic acid | 1 | part, |
| myristic acid | 1 | part, and |
| methyl ethyl ketone | 50 | parts |
| were further added thereto, and stirred and mixed for | | |
| additional 20 miutes, and filtered using a filter | | |
| having an average pore size of 1 μm to give a | | |
| magnetic coating solution. | | |

<Preparation of Magnetic Recording Medium>

As a non-magnetic support, a polyethylene naphthalate having a thickness of 7 μm and a center line average roughness Ra of 6.2 nm was used.

Firstly, a first radiation curing layer coating solution was coated on the surface of the non-magnetic support so as to give the dry thickness of 0.3 μm using a coil bar, which was then dried. The surface of the coating was exposed to an electron beam at an acceleration voltage of 100 kV and an absorbed dose of 30 kGy to cure the coating, thereby forming a first radiation-cured layer.

Then, on the first radiation-cured layer, a second radiation curing layer coating solution was coated so as to give the dry thickness of 0.3 μm using a coil bar, which was then dried. The surface of the coating was exposed to an electron beam at an acceleration voltage of 100 kV and an absorbed dose of 30 kGy to cure the coating, thereby forming a second radiation-cured layer.

Next, on the second radiation-cured layer, a third radiation curing layer coating solution was coated so as to give the dry thickness of 0.3 μm, which was then dried. The surface of the coating was exposed to an electron beam at an acceleration voltage of 100 kV and an absorbed dose of 30 kGy to cure the coating, thereby forming a third radiation-cured layer.

Next, on the third radiation-cured layer, a magnetic coating solution was applied so as to give the dry thickness of 100 nm using reverse rolls. Before the magnetic coating solution had dried, it was subjected to magnetic field alignment using a 5,000 G Co magnet and a 4,000 G solenoid magnet, and after the solvent was removed by drying, it was subjected to a calender treatment employing a metal roll-metal roll-metal roll-metal roll-metal roll-metal roll-metal roll combination (speed 100 m/min, line pressure 300 kg/cm, temperature 90° C.) and then slit to a width of 3.8 mm.

### Example 2

The procedure of Example 1 was repeated except for replacing the urethane acrylate oligomer A with epoxy ester acrylate oligomer B (Ebercryl 3702, manufactured by DAICEL-UCB).

### Example 3

The procedure of Example 1 was repeated except for changing the coating thickness of the first urethane acrylate oligomer A layer to 0.6 μm, and not coating the second urethane acrylate oligomer A layer.

### Example 4

The procedure of Example 1 was repeated except for changing the coating thickness of the first and second urethane acrylate oligomer A layers to 0.45 μm, respectivly, and not coating the non-magnetic coating solution (the third radiation curing layer coating solution).

### Comparative Example 1

The procedure of Example 1 was repeated except for coating none of two urethane acrylate A layer solutions and changing the coating thickness of the non-magnetic coating layer (the third radiation curing layer) to 0.9 μm.

### Comparative Example 2

The procedure of Example 1 was repeated except for changing the coating thickness of the first urethane acrylate A layer to 0.9 μm and not coating the second urethane acrylate A layer coating solution and non-magnetic coating solution (the third radiation curing layer coating solution).

### Comparative Example 3

The procedure of Example 1 was repeated except for coating none of two urethane acrylate A layer solutions, and coating the magnetic layer alone without coating the non-magnetic layer coating solution (third radiation curing layer coating solution).

Measurement Methods

(1) Surface Roughness Ra of Respective Layers

In the case of a radiation-cured layer, it was exposed to an electron beam without coating subsequent layers and then a sample thereof was collected, whose surface was examined by an AFM to give a center line average roughness Ra (nm). With regard to the measurement of the magnetic layer surface, the surface roughness Ra of a tape sample was also measured in the same way as thar for the above-mentioned radiation-cured layer.

(2) Electromagnetic Conversion Characteristics

A single frequency signal at 4.7 MHz was recorded using a DDS4 drive at an optimum recording current, and its playback output was measured. The respective playback outputs in Examples 1 to 4 and Comparative Examples 1 to 3 were expressed as a relative value where the playback output of Comparative Example 1 as 0 dB.

Measurment results are shown below for Examples 1 to 4 and Comparative Examples 1 to 3.

TABLE 1

| | | | Second | | Third Radiation-cured | | | | | | |
|---|---|---|---|---|---|---|---|---|---|---|---|
| | | | Radiation-cured | | Layer (non-magnetic | | AFM surface | | | | |
| | First Radiation-cured | | Layer | | coating solution) | | roughness Ra (nm) | | | | Electromagnetic |
| | Layer | | | Thick- | | Thick- | First | Second | Third | | conversion |
| | | Thickness | | ness | Radiation curing | ness | cured | cured | cured | Magnetic | characteristics |
| | Compound | (μm) | Compound | (μm) | compound | (μm) | layer | layer | layer | layer | (dB) |
| Example 1 | Urethane | 0.3 | Urethane | 0.3 | Urethane acrylate A/ | 0.3 | 1.9 | 1.3 | 1.1 | 1.2 | 1.5 |
| | acrylate A | | acrylate A | | DPHA | | | | | | |
| Example 2 | Epoxy ester | 0.3 | Urethane | 0.3 | Urethane acrylate A/ | 0.3 | 2.0 | 1.4 | 1.2 | 1.3 | 1.3 |
| | acrylate B | | acrylate A | | DPHA | | | | | | |
| Example 3 | Urethane | 0.6 | Not coated | 0 | Urethane acrylate A/ | 0.3 | 1.8 | | 1.4 | 1.5 | 1.0 |
| | acrylate A | | | | DPHA | | | | | | |
| Example 4 | Urethane | 0.45 | Urethane | 0.45 | Not coated | 0 | 1.8 | 1.2 | | 1.4 | 1.2 |
| | acrylate A | | acrylate A | | | | | | | | |
| Comparative | Not coated | 0 | Not coated | 0 | Urethane acrylate A/ | 0.9 | | | 2.3 | 2.4 | 0.0 |
| example 1 | | | | | DPHA | | | | | | |
| Comparative | Urethane | 0.9 | Not coated | 0 | Not coated | 0 | 1.8 | | | 2.0 | 0.4 |
| example 2 | acrylate A | | | | | | | | | | |
| Comparative | Not coated | 0 | Not coated | 0 | Not coated | 0 | | | | 6.1 | −9.4 |
| example 3 | | | | | | | | | | | |

Urethane acrylate A: HEA/MDI/PPG600/MDI/HEA
HEA: hydroxyethyl acrylate,
MDI: diphenylmethane diisocyanate,
PPG600: polypropyrene glycol (moleculare weight: about 600)
Epoxy ester acrylate B: Ebercryl 3702, manufactured by DAICEL-UCB
DPHA: dipentaerythritol hexaacrylate

What is claimed is:

1. A magnetic recording medium comprising:
a non-magnetic support,
at least one magnetic layer provided above the non-magnetic support, the magnetic layer comprising a ferromagnetic powder dispersed in a binder, and
at least two radiation-cured layers provided between the non-magnetic support and the magnetic layer, each of the radiation-cured layers having been cured by exposing a radiation curing compound-containing layer to radiation.

2. A process for producing the magnetic recording medium described in claim 1, comprising the steps of:
coating a radiation curing compound-containing layer on a non-magnetic support and curing the layer by exposure to radiation to form a first radiation-cured layer, and
coating a radiation curing compound-containing layer on the first radiation-cured layer and curing the layer by exposure to radiation to form a second radiation-cured layer.

3. The magnetic recording medium according to claim 1, wherein the number of the radiation-cured layers is 2 or 3.

4. The magnetic recording medium according to claim 3, wherein the number of the radiation-cured layers is 3.

5. The magnetic recording medium according to claim 1, wherein the radiation curing compound is a compound having an ethylenic unsaturated bond or a compound including a cyclic ether.

6. The magnetic recording medium according to claim 5, wherein the radiation curing compound is a compound having an ethylenic unsaturated bond.

7. The magnetic recording medium according to claim 6, wherein the radiation curing compound is a polyfunctional (meth)acrylate compound.

8. The magnetic recording medium according to claim 7, wherein the radiation curing compound is a 2- to 6-functional (meth)acrylate compound.

9. The magnetic recording medium according to claim 1, wherein the radiation curing compound has a molecular weight of 200 to 10,000.

10. The magnetic recording medium according to claim 1, wherein the radiation is an electron beam or ultraviolet rays.

11. The magnetic recording medium according to claim 1, wherein the each of the radiation-cured layers has a thickness of 0.05 to 1.0 μm.

12. The magnetic recording medium according to claim 1, wherein the total thickness obtained by summing the thickness of respective radiation-cured layers is 0.15 to 3.0 μm.

13. The magnetic recording medium according to claim 1, wherein the magnetic layer has a thickness of 0.01 to 0.20 μm.

14. The magnetic recording medium according to claim 1, wherein each of the radiation-cured layers has a surface roughness Ra of 1 to 3 nm.

15. The magnetic recording medium according to claim 1, wherein the magnetic recording medium has a surface roughness Ra of 0.1 to 4.0 nm.
